(19) United States
(12) Patent Application Publication
(10) Pub. No.: US 2026/0181121 A1
(43) Pub. Date: Jun. 25, 2026

(54) INFORMATION PROCESSING APPARATUS, FIGURE CREATION APPARATUS, INFORMATION PROCESSING METHOD, FIGURE CREATION METHOD, AND STORAGE MEDIUM

(71) Applicant: CANON KABUSHIKI KAISHA, Tokyo (JP)

(72) Inventors: Hironao ITO, Kanagawa (JP); Mamoru TANAE, Tokyo (JP); Azusa MATSUMOTO, Kanagawa (JP)

(21) Appl. No.: 19/426,992

(22) Filed: Dec. 19, 2025

(30) Foreign Application Priority Data
Dec. 25, 2024 (JP) 2024-229348

(51) Int. Cl. H04N 13/279

(52) U.S. Cl. CPC H04N 13/279

(57) ABSTRACT

An information processing apparatus acquires a captured image including a figure, receives a virtual viewpoint image stored in association with a state of the figure included in the captured image from a storage apparatus in which different virtual viewpoint images are associated with a plurality of respective states of the figure, and performs a process of displaying the received virtual viewpoint image.

### BACKGROUND

### Field of the Technology

The present disclosure relates to processing based on data obtained by image capturing.

### Description of the Related Art

Based on three-dimensional shape data of an object obtained by capturing images of or scanning a real person or the like, a figure of the person or the like is generated using a 3D printer or the like. In addition, there is a technique of calculating the position, the posture, and the like of a mobile terminal such as a smartphone or a tablet based on a captured image obtained by capturing a two-dimensional marker with the mobile terminal, and generating a virtual viewpoint image viewed from a virtual viewpoint according to the calculated position and posture.

Japanese Patent Laid-Open No. 2022-131778 discloses a technique in which, in a case where an image of a figure generated based on three-dimensional shape data of a player in a target scene is captured, a virtual viewpoint image of the target scene viewed from a virtual viewpoint according to the position and posture of a camera at the time of image capturing is generated.

### SUMMARY

An information processing apparatus of the present disclosure includes one or more memories storing instructions; and one or more processors executing the instructions to: acquire a captured image including a figure; receive a virtual viewpoint image stored in association with a state of the figure included in the captured image from a storage apparatus in which different virtual viewpoint images are associated with a plurality of respective states of the figure; and perform a process of displaying the received virtual viewpoint image.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams illustrating a system configuration;

FIG. 2 is a diagram illustrating an example of a hardware configuration of an image acquisition apparatus and a figure creation apparatus;

FIG. 3 is a sequence diagram for describing a flow of processing between systems;

FIG. 4 is a diagram for describing a functional configuration of the figure creation apparatus;

FIGS. 5A to 5C are diagrams for describing a figure;

FIGS. 6A to 6C are diagrams illustrating data for managing information on the figure and virtual viewpoint images in association with each other;

FIG. 7 is a flowchart for describing a figure creation process;

FIG. 8 is a diagram for describing a functional configuration of the image acquisition apparatus;

FIG. 9 is a flowchart for describing a process of displaying a virtual viewpoint image;

FIGS. 10A and 10B are diagrams for describing a process of displaying a virtual viewpoint image;

FIG. 11 is a diagram illustrating a system configuration; and

FIGS. 12A and 12B are diagrams for describing a process of displaying a virtual viewpoint image.

### DESCRIPTION OF THE EMBODIMENTS

The following will describe embodiments of the present disclosure with reference to the drawings. Note that the following embodiments are not intended to limit the techniques of the present disclosure, and all combinations of the features described in the following embodiments are not necessarily essential for the solving means of the present disclosure. In addition, the same components will be described using the same reference numeral.

### Embodiment 1

This embodiment will describe a system that, in a case where a user who bought a 3D model figure captures an image of the 3D model figure, allows an associated virtual viewpoint image to be displayed to the user.

### About Volumetric Data

Volumetric data is data of a plurality of frames of 3D models representing the three-dimensional shapes of objects such as a plurality of players playing a game held in a stadium or the like and texture images corresponding to the 3D models. A 3D model is also referred to as three-dimensional shape data. For example, this embodiment assumes that one piece of volumetric data includes 3D models of players who participated in a game and texture images corresponding to the 3D models for each set of a plurality of frames (timecodes) corresponding to one game.

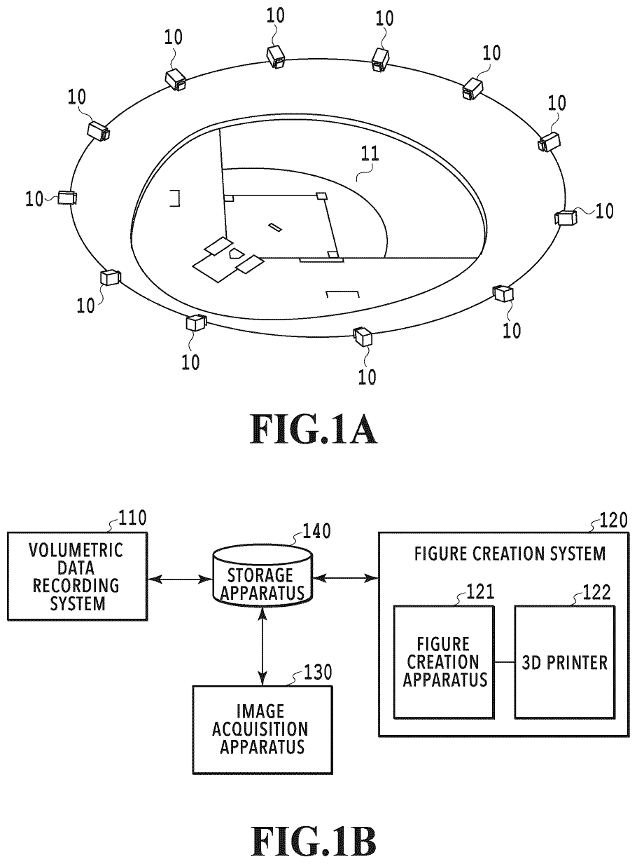

FIG. 1A is a diagram illustrating an example of arrangement of image capturing apparatuses for generating volumetric data including 3D models and the like of players, a ball, and the like in a stadium. A plurality of image capturing apparatuses 10 are installed to surround a target area 11, which is the field of a stadium and its surrounding area, and capture images of the target area 11 from various angles in time synchronization with each other. Targets for generation of volumetric data may be all sports, such as soccer, baseball, rugby, volleyball, table tennis, concerts, or various events, and targets for generation of volumetric data are not limited.

Volumetric data is generated by capturing images of the target area 11 for which volumetric data is to be generated with the plurality of image capturing apparatuses 10 and processing the captured image data. For example, although not fully illustrated in FIG. 1A, for example, one hundred image capturing apparatuses are installed in the stadium having the target area 11, and images captured by the one hundred image capturing apparatuses are used to generate volumetric data.

For example, the one hundred image capturing apparatuses capture images of the target area 11 in time synchronization with each other, and a process of acquiring images captured by the one hundred image capturing apparatuses frame by frame is performed. Then, a process of extracting a foreground area, which is the area of objects such as players, from each of the images captured by the one hundred image capturing apparatuses is performed. Methods of extracting the foreground area from a captured image include a method of extracting the foreground area by comparing a background image generated based on an input captured image with the input captured image. For example, among the pixels of the input captured image, pixels having differences in RGB values from the corresponding pixels in the background image greater than or equal to a determination threshold can be determined as the foreground area. Besides, the method of extracting the foreground area may be any method as long as it is a method for image comparison. Information indicating the extracted foreground area may be a 1-bit image which has the same image size as the captured image and in which the foreground area is represented by white and the background area is represented by black for each pixel. Alternatively, information indicating the foreground area has only to be information that can indicate the foreground area, and is not particularly limited.

The extracted foreground area, external parameters that are information on the position and posture of each of the one hundred image capturing apparatuses acquired in advance, internal parameters such as the focal length of the lens, the angle of view, and the aperture, and distortion parameters are used to generate 3D models corresponding to the foreground area. Methods of generating 3D models include, for example, a method of estimating the three-dimensional shapes using the visual hull method. The 3D model generation process results in point cloud information in which objects such as players are expressed with three-dimensional shapes. Furthermore, processing the obtained point cloud using a general three-dimensional labeling method based on the presence or absence of adjacent points divides it into point cloud information for each object. Each point is assigned an object ID that is the result of labeling, and point cloud information for each object can be obtained by specifying the object ID. The method of generating 3D models is not limited to this method, but various schemes can be used. In addition, a variety of formats can be used as the 3D model format, for example, meshes can also be used. Repeating this process frame by frame allows obtaining volumetric data for all players in one game.

### About Virtual Viewpoint Image

A virtual viewpoint image is an image that is generated to be an image of objects such as players in the target area 11 as shown in FIG. 1A viewed from a virtual viewpoint different from the actual viewpoint of the image capturing apparatus. A virtual viewpoint image may be a moving image or a still image. This embodiment will describe a virtual viewpoint image as a moving image (video) composed of a plurality of frames. Volumetric data is used to reproduce the 3D space of the target area 11 in which the 3D models of objects such as players are placed, and generate a virtual viewpoint image by performing rendering processing so that it becomes an image of the 3D space viewed from a virtual viewpoint. In a case where a virtual viewpoint is replaced with a virtual camera, a virtual viewpoint image corresponds to a captured image obtained by being virtually captured by the virtual camera. In addition, the position of the virtual camera corresponds to the position of the virtual viewpoint, and the orientation of the virtual camera corresponds to the line-of-sight direction. In this way, volumetric data enables generation of a virtual viewpoint image that captures the target area 11 at a desired time from a desired viewpoint.

### System Configuration

FIG. 1B is an example of a configuration of a system of this embodiment. The system of this embodiment includes a volumetric data recording system 110, a figure creation system 120, an image acquisition apparatus 130, and a storage apparatus 140.

The volumetric data recording system 110 is a system including a generation apparatus that generates volumetric data based on captured images of, for example, sports or the like held in a stadium or the like. The generated volumetric data is uploaded to the storage apparatus 140, such as a database on the cloud, and stored in the storage apparatus 140.

The figure creation system 120 is a system that includes at least a figure creation apparatus 121 and a 3D printer 122. The figure creation apparatus 121 generates data for the 3D printer 122 to model a 3D model figure (also simply referred to as a figure), which is a real modeled article such as a doll, from the volumetric data. The 3D printer 122 creates a figure by modeling the three-dimensional shape of an object based on the data generated by the figure creation apparatus 121. In addition, the figure creation apparatus 121 generates virtual viewpoint images to be associated with the created figure and stores them in the storage apparatus 140. The figure creation apparatus 121 stores the virtual viewpoint images in the storage apparatus 140 in association with information on the created figure. Storing the virtual viewpoint images in this way enables the user to appreciate the virtual viewpoint images linked to the figure. The association of the virtual viewpoint images may be changed according to the state of the figure.

The image acquisition apparatus 130 is an information processing apparatus that, in response to the user capturing an image of the figure created by the figure creation system 120, acquires a virtual viewpoint image associated with the figure and performs a process of displaying the acquired virtual viewpoint image.

### Hardware Configuration

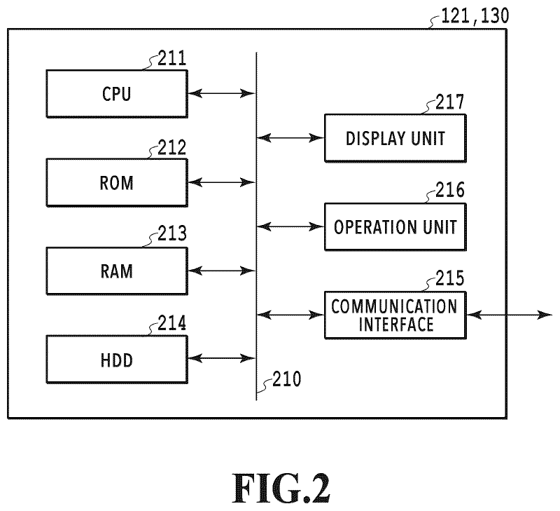

FIG. 2 is a diagram illustrating an example of a hardware configuration of the figure creation apparatus 121 and the image acquisition apparatus 130 of this embodiment.

The figure creation apparatus 121 and the image acquisition apparatus 130 of this embodiment include a CPU 211, a ROM 212, a RAM 213, an HDD 214, a communication interface 215, an operation unit 216, and a display unit 217, which are connected via a system bus 210.

The CPU 211 is a central processing unit, and controls the entire apparatus, for example, deploys computer programs or data stored in the ROM 212 to the RAM 213 and executes the computer programs. The ROM 212 is a storage unit that stores configuration data, boot programs, and the like. The RAM 213 is a storage unit having an area for temporarily storing computer programs and data loaded from the ROM 212, data acquired externally via the communication interface 215, and the like. The RAM 213 has a work area used by the CPU 211 to perform various processes. For example, the RAM 213 can allocate a frame memory, or provide various other areas as needed.

The operation unit 216 includes, for example, a keyboard and a mouse, and receives the user's operation to input various instructions based on the user's operation to the CPU 211. The display unit 217 includes, for example, a liquid crystal display, and displays results of processing by the CPU 211. The CPU 211 operates as a display control unit that controls a screen displayed on the display unit 217, and operates as an operation control unit that controls the operation unit 216. Although this embodiment has described the display unit 217 and the operation unit 216 as being present in the apparatus, at least one of the display unit 217 and the operation unit 216 may be present as a separate apparatus outside the apparatus.

The HDD 214 is a high-capacity information storage unit. The HDD 214 stores an operating system (OS), computer programs for implementing the functional units included in the apparatus, and the like. The HDD 214 may store each image data to be processed. Computer programs and data stored in the HDD 214 are loaded to the RAM 213 as appropriate according to the control by the CPU 211, and are to be processed by the CPU 211.

The communication interface 215 can connect networks such as a LAN and the Internet, and other equipment such as a projection apparatus and a display apparatus. The CPU 211 can acquire or transmit various types of information via the communication interface 215. The system bus 210 is a bus that connects the above units.

### Sequence Diagram

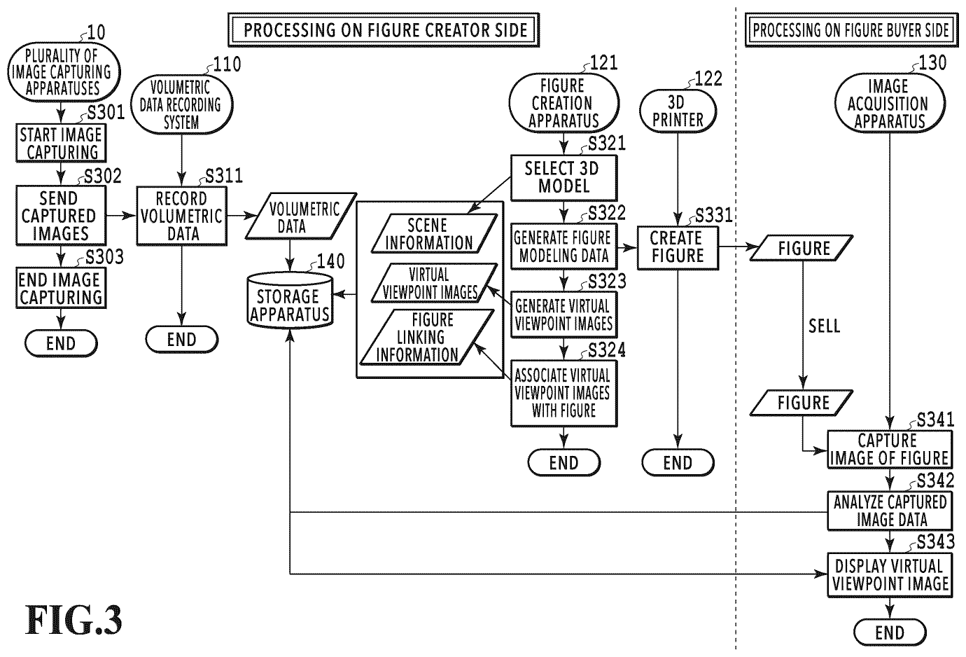

FIG. 3 is a sequence diagram for describing a process flow of the entire system.

In S301, the plurality of image capturing apparatuses 10 as shown in FIGS. 1A and 1B start capturing images of the target area 11. For example, in a case where a game starts in the target area 11, the plurality of image capturing apparatuses 10 start capturing images. In S302, the plurality of image capturing apparatuses 10 send the captured images to the volumetric data recording system 110.

In S311, the volumetric data recording system 110 generates volumetric data based on the captured images sent from the plurality of image capturing apparatuses 10, and stores the generated volumetric data in the storage apparatus 140. In S303, the plurality of image capturing apparatuses 10 end image capturing. For example, in a case where the game played in the target area 11 is over, the plurality of image capturing apparatuses 10 end image capturing.

In S321, the figure creation apparatus 121 selects a scene from which a figure is to be created and a target 3D model corresponding to a player in the scene from the volumetric data stored in the storage apparatus 140. How to select the target 3D model will be described later.

In S322, the figure creation apparatus 121 converts the data of the target 3D model selected in S321 into data that can be input to the 3D printer to generate figure modeling data. S322 also includes a process of data processing, such as adding reinforcing members to parts that are too thin and may break.

In S323, the figure creation apparatus 121 generates a plurality of virtual viewpoint images different from each other.

In S324, the figure creation system 120 associates information indicating the state of the figure at the time of image capturing with the virtual viewpoint images generated in S323, and stores the virtual viewpoint images in the storage apparatus 140. How to generate virtual viewpoint images and the like will be described later.

In S331, the 3D printer 122 creates a figure based on the figure modeling data generated in S322. The figure created in S331 is a figure associated with the virtual viewpoint images generated in S323. In this way, in this embodiment, a figure associated with virtual viewpoint images is sold.

A user buys the figure created in S331. The user who bought the figure is taken to a flow for appreciating virtual viewpoint images associated with the bought figure.

In S341, the image acquisition apparatus 130 acquires a captured image obtained by the user capturing an image of the figure created in S331. For example, in a case where the image acquisition apparatus 130 is a terminal with an image capturing unit like a smartphone, a captured image obtained by the image acquisition unit of the image acquisition apparatus 130 capturing an image of the figure is acquired in S341.

In S342, the image acquisition apparatus 130 analyzes the captured image acquired in S341, and receives a virtual viewpoint image from the storage apparatus 140 based on the analysis result.

In S343, the image acquisition apparatus 130 displays the virtual viewpoint image received in S342 to the user. For example, in a case where the image acquisition apparatus 130 is a terminal with a display unit like a smartphone, the virtual viewpoint image received in S342 is displayed on the display unit of the image acquisition apparatus 130 in S343.

In this way, in this embodiment, in a case where an image of the figure is captured, a virtual viewpoint image that is stored in advance in association with the figure is displayed. Details on how to analyze the captured image and how to acquire the virtual viewpoint image will be described later.

### Functional Configuration of Figure Creation System

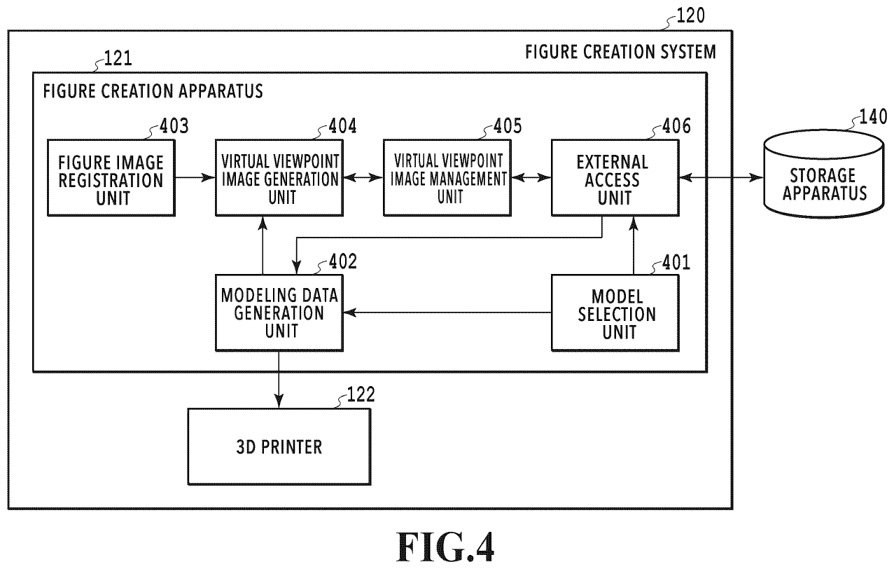

FIG. 4 is a block diagram for describing an example of a functional configuration of the figure creation apparatus 121 included in the figure creation system.

The figure creation apparatus 121 includes a model selection unit 401, a modeling data generation unit 402, a virtual viewpoint image generation unit 404, a virtual viewpoint image management unit 405, and an external access unit 406. In addition, as described later, the figure creation apparatus 121 may include a figure image registration unit 403.

The model selection unit 401 selects a 3D model (referred to as a target 3D model) representing the three-dimensional shape of an object in a scene from which a figure is to be created based on the specification by a figure creator.

The figure creator specifies a scene from which a figure is to be created (referred to as a target scene) and an object (referred to as a target object) in the following procedure. Note that the figure creator is not limited to a single person, and people involved in the creation of the figure shall be collectively referred to as the figure creator. A user who will own the figure to be created from now can also become the figure creator.

First, the figure creator specifies target volumetric data, which is volumetric data including the 3D model of a player whose figure is to be created. For example, the figure creator specifies a target event (game) by inputting volumetric data information, which is information such as a volumetric data ID, target teams (matchup), and a game date, to the storage apparatus 140. The volumetric data ID is an identifier for identifying volumetric data. The user may specify the volumetric data by inputting an information item included in the volumetric data information. The model selection unit 401 accesses the storage apparatus 140 via the external access unit 406 to acquire the target volumetric data, which is the volumetric data specified by the user. As mentioned above, volumetric data includes 3D models for each set of frames (timecodes) for one game.

Next, the figure creator specifies a time range (scene) by specifying the start time code and the end time code, and sets the position and posture of the virtual camera. The model selection unit 401 generates a virtual viewpoint image according to the specified time range and the virtual camera from the target volumetric data, and displays the generated virtual viewpoint image on the display unit of the figure creation apparatus 121. The figure creator selects a target frame from the virtual viewpoint image, and selects a target object such as a player whose figure is to be created from the target frame. The model selection unit 401 selects a 3D model representing the three-dimensional shape of the target object selected from the target frame as a target 3D model from which a figure is to be created. At this time, the scene specified by the figure creator is the target scene. The model selection unit 401 assigns the target scene a scene ID for uniquely identifying the scene. Information indicating the target scene specified by the figure creator is referred to as scene information. The scene information includes a scene ID, a start timecode, and an end timecode. In this way, in a case where a target scene is specified from the target volumetric data, a target frame is specified from the target scene, and a target object is specified from the target frame, the model selection unit 401 selects the target 3D model representing the target object.

In a case where the model selection unit 401 selects the target 3D model, volumetric data information for identifying the target volumetric data, scene information for identifying the target scene, and information for identifying the target frame are output to the modeling data generation unit 402. Furthermore, information for identifying the target 3D model is output to the modeling data generation unit 402. These information items are used to acquire the target 3D model from the storage apparatus 140.

The modeling data generation unit 402 generates figure modeling data corresponding to the target 3D model.

First, the modeling data generation unit 402 acquires the target 3D model and the texture for coloring the three-dimensional shape represented by the target 3D model from the storage apparatus 140 via the external access unit 406 based on the information output from the model selection unit 401. The modeling data generation unit 402 generates figure modeling data, such as a mesh model that enables modeling by the 3D printer 122, using the target 3D model and the texture.

Furthermore, the modeling data generation unit 402 generates information for identifying the state in a captured image in a case where the figure created based on the target 3D model is captured. This embodiment will provide a description assuming that information for identifying the orientation of the figure is generated. The information for identifying the orientation is assumed to be a code image, such as a two-dimensional code. The modeling data generation unit 402 generates modeling data of a base of the figure so that the generated two-dimensional code is assigned to the base. The modeling data generation unit 402 generates figure modeling data that combines a mesh model of a 3D model representing the three-dimensional shape of an object such as a player and a base with a two-dimensional code assigned as a texture. The modeling data generation unit 402 outputs the figure modeling data to the 3D printer 122.

The 3D printer 122 receives the figure modeling data from the modeling data generation unit 402, and three-dimensionally models the target object using the received figure modeling data to create a real figure.

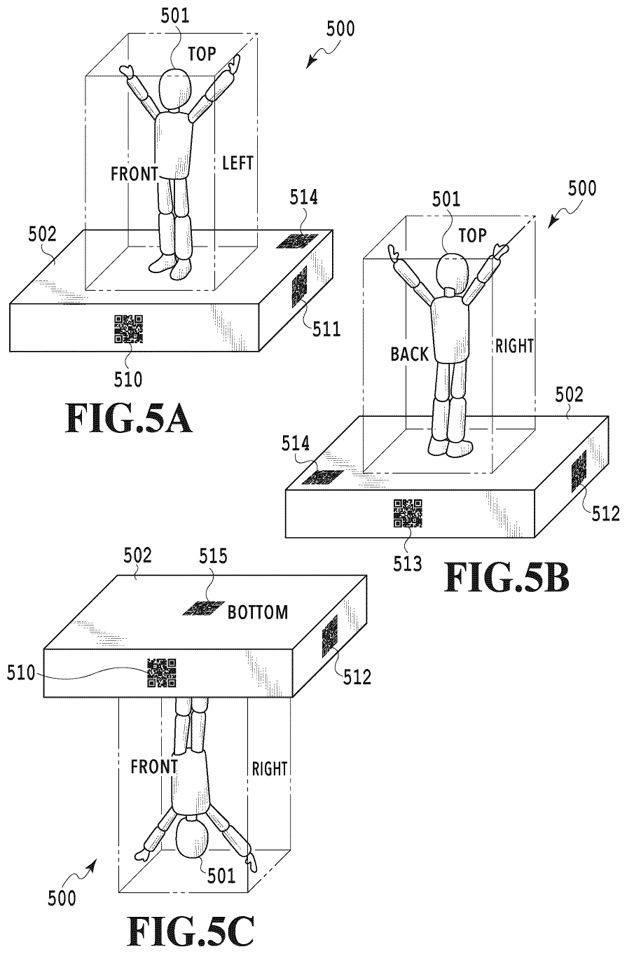

FIGS. 5A to 5C are diagrams for describing a created figure. FIG. 5A is a diagram of a FIG. 500 viewed from the front. FIG. 5B is a diagram of the FIG. 500 viewed from the back. FIG. 5C is a diagram of the FIG. 500 viewed from the bottom.

The modeling data generation unit 402 generates two-dimensional codes that encode information on the orientations of the figure in order to identify the orientation of the figure in a captured image in a case where the user captures an image of the figure. For example, the modeling data generation unit 402 generates two-dimensional codes that encode information on their respective orientations in six directions (front, right, left, back, top, and bottom). Then, in a case of generating the figure modeling data, the modeling data generation unit 402 assigns a two-dimensional code for the front on the front side of the base and a two-dimensional code for the back on the back side of the base as textures. This embodiment assumes that a code for the top is assigned to the top of the base, and a code for the bottom is assigned to the bottom of the base. As a result, the generated FIG. 500 includes at least a figure body 501 and a base 502, and is assigned two-dimensional codes 510-515 representing their respective orientations in the six directions of the base 502, as shown in FIGS. 5A to 5C. There are the two-dimensional code 510 assigned to the front of the figure, the two-dimensional code 511 assigned to the right, the two-dimensional code 512 assigned to the left, the two-dimensional code 513 assigned to the back, the two-dimensional code 514 assigned to the top, and the two-dimensional code 515 assigned to the bottom. Thus, analyzing the two-dimensional code included in a captured image obtained by capturing the FIG. 500 allows identification of the orientation of the figure in the captured image in a case where the FIG. 500 is captured.

The information encoded in the two-dimensional codes 510-515 further includes information for accessing the storage apparatus 140 and information for identifying the captured figure in addition to the information on the orientations of the figure. For example, the information encoded in a two-dimensional code includes a figure ID for identifying the figure. Furthermore, it may include a scene ID for identifying the target scene used to create the figure, and a volumetric data ID for identifying the target volumetric data.

Although this embodiment has described the information identifying the orientation of the figure in a captured image as a two-dimensional code, in addition to this, the figure modeling data may be generated so that a code that is difficult for the human eye to see is assigned to the FIG. 500.

The virtual viewpoint image generation unit 404 generates virtual viewpoint images associated with the orientations of the FIG. 500. As an example, this embodiment assumes that the virtual viewpoint image generation unit 404 generates virtual viewpoint images based on instructions from the figure creator. The figure creator specifies the camerawork of the virtual camera using the operation unit. The virtual viewpoint image generation unit 404 generates a virtual viewpoint image so that it becomes an image captured by the virtual camera specified by the figure creator. The virtual viewpoint image generation unit 404 generates a different virtual viewpoint image for each orientation of the FIG. 500.

The virtual viewpoint image management unit 405 performs a process of uploading the plurality of virtual viewpoint images generated by the virtual viewpoint image generation unit 404 to the storage apparatus 140 to store the virtual viewpoint images in advance in the storage apparatus 140. In addition, the virtual viewpoint image management unit 405 stores the virtual viewpoint images in the storage apparatus 140 in association with the figure ID for identifying the FIG. 500. Furthermore, this embodiment assumes that each of the generated virtual viewpoint images is stored in further association with information indicating the orientation of the figure. For example, a two-dimensional code on the base of the figure encodes information indicating the orientation of the figure as the state of the figure. For this reason, the virtual viewpoint image management unit 405 performs a process of storing a virtual viewpoint image generated to be associated with a certain orientation of the figure in the storage apparatus 140 in association with the figure ID indicating the figure and the information indicating the orientation of the figure. Information including the figure ID, the information indicating the orientation of the figure, and the information indicating the virtual viewpoint image is referred to as figure information.

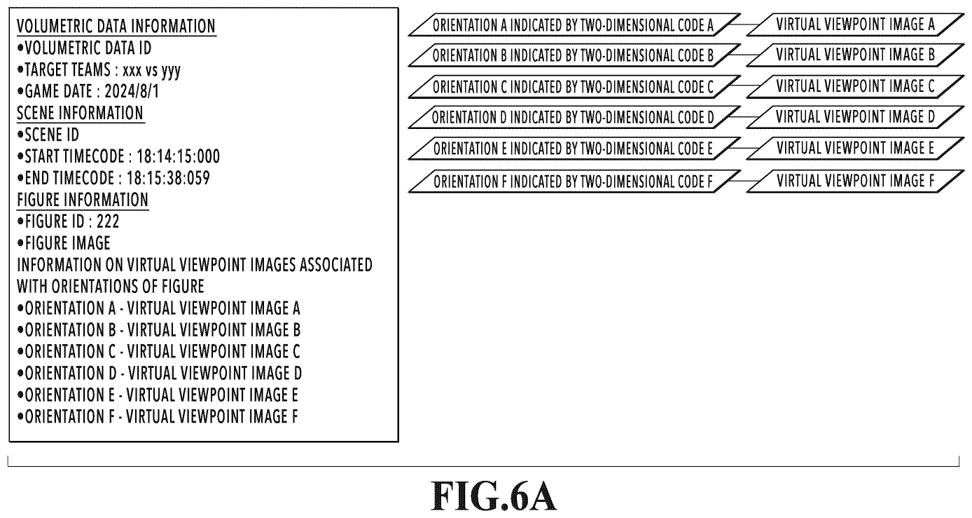

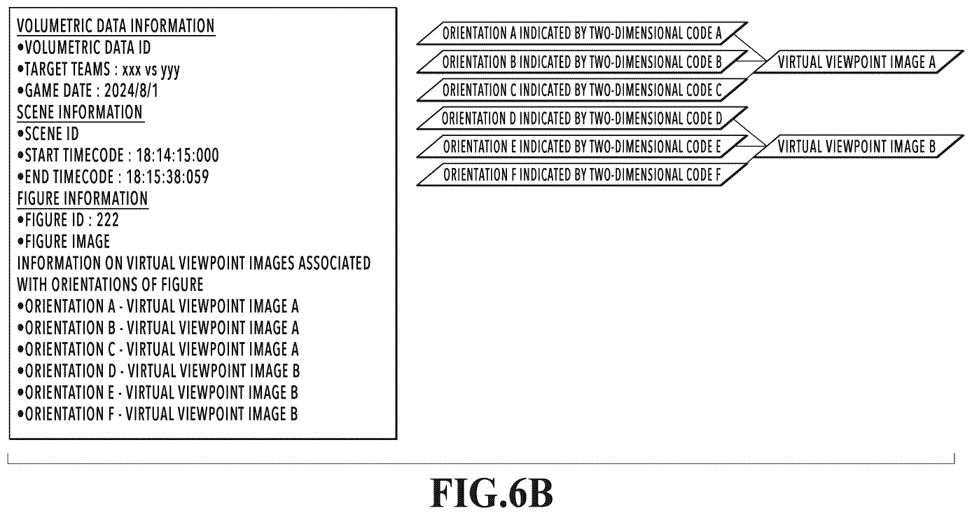

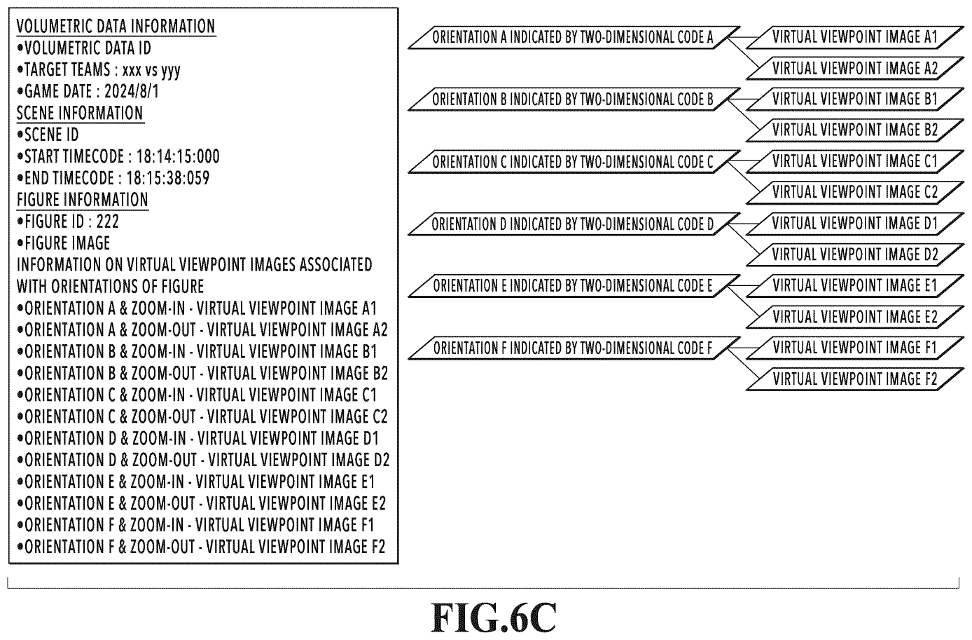

FIGS. 6A to 6C show examples of data for managing the figure information, which is information associated with the virtual viewpoint images generated by the virtual viewpoint image generation unit 404 and stored in the storage apparatus 140. As shown in FIGS. 6A to 6C, the figure information may be associated with the volumetric data information identifying the volumetric data used to create the figure and the scene information identifying the target scene. In this way, managing the figure information in association with the volumetric data information and the scene information can improve the searchability in a case of searching for a target figure or a virtual viewpoint image. For this reason, the volumetric data information, the scene information, and the figure information are acquired from the modeling data generation unit 402 and uploaded to the storage apparatus 140 via the external access unit 406.

Various methods are conceivable as a method for managing the virtual viewpoint images generated by the virtual viewpoint image generation unit 404 in the storage apparatus 140.

For example, the virtual viewpoint image generation unit 404 generates six different virtual viewpoint images A-F as virtual viewpoint images associated with a figure. The virtual viewpoint image management unit 405 is assumed to store the virtual viewpoint images A-F in the storage apparatus 140 in association with the six orientations of the figure. In this case, for example, as shown by the figure information in FIG. 6A, the figure ID for identifying the figure is associated with the virtual viewpoint images A-F. Furthermore, the virtual viewpoint images A-F are stored with the six orientations A-F of the figure associated with the virtual viewpoint images A-F one by one.

Alternatively, the virtual viewpoint image generation unit 404 generates two different virtual viewpoint images A and B as virtual viewpoint images associated with a figure. The virtual viewpoint image management unit 405 is assumed to store the virtual viewpoint images A and B in the storage apparatus 140 in association with the six orientations of the figure. In this case, as shown in FIG. 6B, the virtual viewpoint images are stored in the storage apparatus 140 with the virtual viewpoint image A associated with the orientations A, B, and C, and with the virtual viewpoint image B associated with the orientations D, E, and F, among the six orientations A-F. In this way, the number of orientations of the figure may not coincide with the number of virtual viewpoint images.

Each functional unit shown in FIG. 4 is implemented by the CPU of the figure creation apparatus 121 executing a predetermined program, but the present disclosure is not limited to this. In addition to this, for example, hardware such as a graphics processing unit (GPU) or a field programmable gate array (FPGA) for accelerating the computations may be used. Each functional unit may be implemented by collaboration of software and hardware such as dedicated ICs, or some or all functions may be implemented only by hardware.

### About Virtual Viewpoint Images Associated With Figure

It is conceivable to generate virtual viewpoint images using four schemes as examples of virtual viewpoint images associated with a figure. Note that a description will be provided assuming that the target scene is a sports scene and the target object for which the figure has been created is a player Z.
(1) Generate a virtual viewpoint image that reflects the direction of image capturing

The scheme (1) is a scheme of generating virtual viewpoint images of the player Z who is the target object in the target scene used to create the figure viewed from the respective orientations corresponding to the two-dimensional codes. For example, a virtual viewpoint image A captured by the virtual camera in a camerawork that captures the player Z in the target scene mainly from the front is generated. The virtual viewpoint image A is stored in association with the orientation indicated by the two-dimensional code 510 for the front. In the same way, a virtual viewpoint image B captured by the virtual camera in a camerawork that captures the player Z in the target scene from the right is generated, and the virtual viewpoint image B is stored in association with the orientation indicated by the two-dimensional code 512 for the right. In this way, a virtual viewpoint image like an image of the target object in the target scene captured in a camerawork centered on the orientation of the virtual camera corresponding to an orientation of the figure is generated, and the generated virtual viewpoint image is stored in association with the orientation of the figure. Since the scheme (1) links a virtual viewpoint image to the orientation in which the user captures the image, it has the effect that it is easy for the user to imagine a virtual viewpoint image that they can appreciate.
(2) Generate a virtual viewpoint image of the target object in another scene other than the target scene

The scheme (2) is a scheme of generating a virtual viewpoint image of the player Z who is the target object in another scene different from the target scene captured with the virtual camera. For example, a virtual viewpoint image B of the player Z in another scene captured with the virtual camera is generated, and the virtual viewpoint image B of the other scene is stored in association with an orientation such as right, left, or back, which is one of the orientations other than front indicated by the two-dimensional codes 511-515. In addition, a virtual viewpoint image A captured by the virtual camera in a camerawork that captures the player Z in the target scene mainly from the front is generated, and the virtual viewpoint image A is stored in association with the orientation indicated by the two-dimensional code 510 for the front. Since the user usually captures an image of the figure from the front, the virtual viewpoint image A of the target scene from which the figure was created may be stored in association with the orientation indicated by the two-dimensional code 510 indicating the front. For example, in the case of baseball, the target scene may be a home run scene of the player Z, and another scene may be the previous at-bat scene of the player Z. Alternatively, the target scene may be a scene in which the player Z was happy, and another scene may be the home run scene that led to the scene in which the player Z was happy. Associating and storing a virtual viewpoint image of another scene in this way allows the user to enjoy a virtual viewpoint image of a related scene such as a scene that triggered the target scene by capturing an image of the figure from a direction other than the front. In addition, in a case where a three-hit game was achieved by making three or more hits in one day, virtual viewpoint images may be generated with other hit scenes and home run scenes as separate scenes. In this way, storing virtual viewpoint images of another scene related to the target object in association with orientations of the object allows the user to appreciate many scenes in which the player who is the target object performed well.
(3) Generate a virtual viewpoint image of another player in the target scene

The scheme (3) is a scheme of generating a virtual viewpoint image of another player different from the player who is the target object in the target scene captured with the virtual camera. For example, a virtual viewpoint image B of a player Y different from the target object in the target scene captured with the virtual camera is generated, and the virtual viewpoint image B is stored in association with an orientation such as right, left, or back, which is one of the orientations other than front indicated by the two-dimensional codes 511-515. In addition, for the same reason as the scheme (2), a virtual viewpoint image A captured by the virtual camera in a camerawork that captures the player Z in the target scene mainly from the front is generated, and the virtual viewpoint image A may be stored in association with the orientation indicated by the two-dimensional code 510 for the front. For example, in the case of baseball, if the target scene is a home run scene of the player Z, a virtual viewpoint image B like an image captured by the virtual camera so that the expression of the player Y such as the pitcher or the catcher who gave up a home run in the target scene can be seen is generated. In the case of soccer, if the target scene is a scoring scene of the player Z, a virtual viewpoint image such that the look of the opposing defense who is the player Y or the expression of happiness of another player Y on the same team as the player Z is captured by the virtual camera is generated as the virtual viewpoint image B. In this way, the user can appreciate the target scene from other aspects.
(4) Generate a virtual viewpoint image of another player in another scene

The scheme (4) is a scheme of generating a virtual viewpoint image of another player different from the player who is the target object in another scene captured with the virtual camera. Another scene is, for example, a scene at a time before or after the target scene. For example, a virtual viewpoint image B of a player Y different from the target object in another scene captured with the virtual camera is generated, and the virtual viewpoint image B is stored in association with an orientation such as right, left, or back, which is one of the orientations other than front indicated by the two-dimensional codes 511-515. In addition, for the same reason as the scheme (2), a virtual viewpoint image A captured by the virtual camera in a camerawork that captures the player Z in the target scene mainly from the front is generated, and the virtual viewpoint image A may be stored in association with the orientation indicated by the two-dimensional code 510 for the front. For example, in the case of baseball, if the target scene is a scene of a timely hit, another scene may be a scene of a hit or a base on balls of the player Y who is the previous batter leading to the timely hit. In addition, in the case of soccer, if the target scene is a scoring scene of the player Z, another scene may be a scene in which another player Y starts to move that leads to the scoring scene. In this way, the user can appreciate related images.

The position and posture of the virtual camera for generating the virtual viewpoint image B in the above schemes (2)-(4) do not have to be related to the associated orientation of the FIG. 500. The virtual viewpoint image B in the above schemes (2)-(4) are intended to include a plurality of virtual viewpoint images different from the virtual viewpoint image A.

Note that the virtual viewpoint images associated with the orientations of the FIG. 500 are not limited to virtual viewpoint images of the event (game) used to generate the FIG. 500. The virtual viewpoint images associated with the orientations of the FIG. 500 may be generated by specifying volumetric data different from the target volumetric data selected in generating the FIG. 500. In addition, the images associated with the orientations of the FIG. 500 are not limited to virtual viewpoint images. For example, an image associated with an orientation of the FIG. 500 may be an actual video or still image captured by one of the plurality of image capturing apparatuses 10, or may be a video or still image separately captured to be associated with the figure. In addition, data associated with the FIG. 500 is not limited to images, but data such as the performance of the player who is the model for the FIG. 500 may also be associated. Alternatively, a combination of these images and data may be associated with orientations of the figure.

### Flowchart

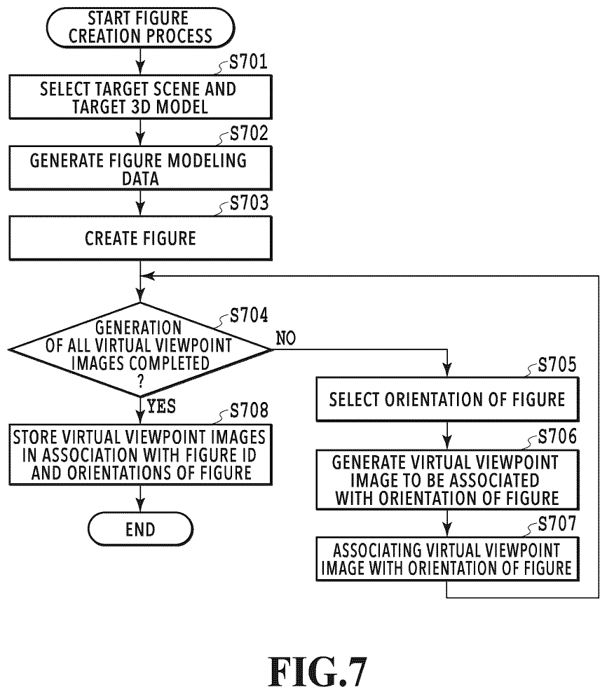

FIG. 7 is a flowchart for describing a process of creating a figure and associating virtual viewpoint images with the figure in this embodiment. The series of processes shown in FIG. 7 is implemented by a program stored in the ROM or the HDD of the figure creation apparatus 121 being deployed on the RAM and executed by the CPU. Alternatively, some or all of the functions of the steps in FIG. 7 may be implemented with hardware, such as ASICs and electronic circuits. The symbol “S” in the description of each process means that it is a step in the flowchart, and the same applies to the subsequent flowcharts.

In S701, the model selection unit 401 generates a virtual viewpoint image corresponding to a target scene in an event (game) specified by the figure creator, and displays the generated virtual viewpoint image on the display unit of the figure creation apparatus 121. In a case where the figure creator selects a target frame and a target object from the virtual viewpoint image, the model selection unit 401 selects the target 3D model corresponding to the target object in the target scene (target frame). The model selection unit 401 sends information for identifying the target 3D model to the modeling data generation unit 402.

In S702, the modeling data generation unit 402 acquires the target 3D model from the storage apparatus 140 and generates figure modeling data based on the target 3D model.

In S703, the modeling data generation unit 402 outputs the figure modeling data to the 3D printer 122, and the 3D printer 122 models the FIG. 500 based on the figure modeling data.

In S704, the virtual viewpoint image generation unit 404 determines whether the generation of virtual viewpoint images associated with the figure generated in S703 has been completed. For example, in a case where the figure creator inputs an instruction to end the generation of virtual viewpoint images, the virtual viewpoint image generation unit 404 determines that the generation of virtual viewpoint image has been completed. If the virtual viewpoint image generation unit 404 determines that the generation of virtual viewpoint images has been completed (YES in S704), the process proceeds to S708, or otherwise (NO in S704), the process proceeds to S705.

In S705, the virtual viewpoint image generation unit 404 selects an orientation of the figure. Note that in S705, a two-dimensional code indicating an orientation of the figure may be selected.

In S706, the virtual viewpoint image generation unit 404 generates a virtual viewpoint image to be associated with the orientation of the figure selected in S705. The figure creator generates a virtual viewpoint image using one of the above schemes (1)-(4) as a virtual viewpoint image to be associated with the orientation of the figure selected in S706. For example, the figure creator selects a scene from the target volumetric data used to generate the figure and sets the position and posture of the virtual camera. The virtual viewpoint image generation unit 404 generates a virtual viewpoint image like an image of the scene reproduced by the volumetric data used to generate the figure captured with the set virtual camera.

In S707, the virtual viewpoint image management unit 405 associates the virtual viewpoint image generated in S706 with the orientation of the figure selected in S705.

Repeatedly executing S705-S707 generates virtual viewpoint images associated with information indicating the orientations of the figure as shown in FIGS. 6A to 6C.

In S708, the virtual viewpoint image management unit 405 collectively uploads the scene information, the figure information, the generated virtual viewpoint images, and the information on the orientations of the figure associated with the virtual viewpoint images to the storage apparatus 140 via the external access unit 406. As a result, the virtual viewpoint images are stored in the storage apparatus 140 in association with the orientations of the figure.

### Process of Displaying Virtual Viewpoint Image

There will be described how the buyer of the figure captures an image of the figure and appreciates a virtual viewpoint image associated with the orientation of the figure at the time of image capturing.

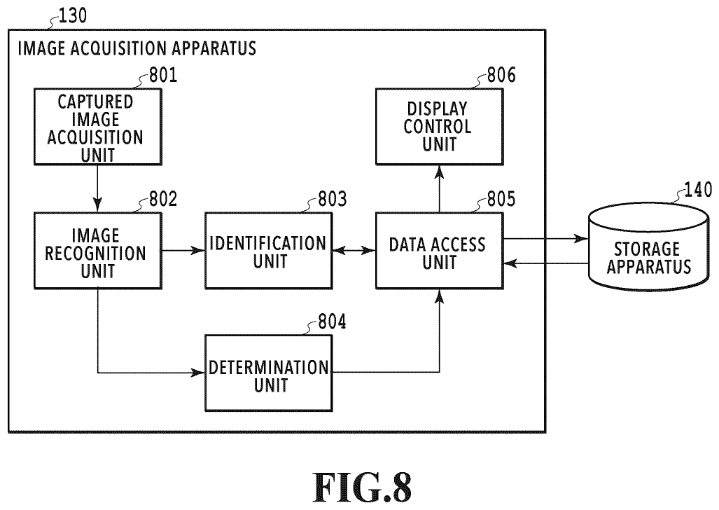

FIG. 8 is a diagram illustrating an example of a functional configuration of the image acquisition apparatus 130. The image acquisition apparatus 130 includes a captured image acquisition unit 801, an image recognition unit 802, a determination unit 804, an identification unit 803, a data access unit 805, and a display control unit 806.

The captured image acquisition unit 801 acquires a captured image obtained by capturing the FIG. 500. For example, suppose that the image acquisition apparatus 130 is the user's terminal with an image capturing unit and a display unit. In this case, the image capturing unit of the image acquisition apparatus 130 captures an image of the FIG. 500 according to the user's operation of the image acquisition apparatus 130, and the captured image acquisition unit 801 acquires the resulting captured image.

The image recognition unit 802 acquires the captured image acquired by the captured image acquisition unit 801, analyzes the acquired captured image, and extracts two-dimensional codes included in the captured image. The image recognition unit 802 outputs information on the positions and sizes of the extracted two-dimensional codes to the determination unit 804. In a case where no two-dimensional code is extracted, the image recognition unit 802 determines that the recognition has failed, and presents an error to the user.

The determination unit 804 determines a two-dimensional code to be decoded among the two-dimensional codes included in the captured image based on the sizes and positions of the two-dimensional codes included in the captured image. As mentioned above, in a case where the two-dimensional codes 510-515 are assigned in the six directions of the FIG. 500, the two-dimensional code captured in the largest size with small distortion among the two-dimensional codes included in the captured image is identified as the two-dimensional code to be decoded. The two-dimensional code to be decoded is used as the two-dimensional code for identifying the orientation of the captured FIG. 500 at the time of image capturing. In this way, in this embodiment, the orientation of the FIG. 500 can be identified from the captured image obtained by capturing the FIG. 500.

The identification unit 803 decodes the two-dimensional code to be decoded and outputs the resulting information to the data access unit 805. The information obtained by decoding the two-dimensional code includes access information to the storage apparatus 140, information for identifying the captured FIG. 500, and information on the orientation of the captured FIG. 500. For this reason, the identification unit 803 can identify the orientation of the FIG. 500 in the captured image as the state of the captured FIG. 500 in the captured image. The information for identifying the captured FIG. 500 is the figure ID as mentioned above. Furthermore, in a case where the volumetric data ID and the scene ID are encoded in the two-dimensional code, the volumetric data ID and the scene ID are also acquired as information for identifying the captured FIG. 500. Note that the information obtained by decoding the two-dimensional code may also be a URL for accessing the virtual viewpoint image associated with the orientation of the FIG. 500 in the captured image. In this case, the URL is the access information to the storage apparatus 140, the information for identifying the captured FIG. 500, and the information on the orientation of the captured figure.

The data access unit 805 accesses the storage apparatus 140 based on the access information. Then, the figure ID for identifying the captured FIG. 500 and the information on the orientation of the figure are input to the storage apparatus 140, and the virtual viewpoint image stored in the storage apparatus 140 in association with the input figure ID and figure orientation is received.

The display control unit 806 performs a process of displaying the received virtual viewpoint image. In a case where the image acquisition apparatus 130 is the user's terminal, the display control unit 806 displays the virtual viewpoint image received by the data access unit 805 on the display unit of the image acquisition apparatus 130.

Each functional unit shown in FIG. 8 is implemented by the CPU of the image acquisition apparatus 130 executing a predetermined program, but the present disclosure is not limited to this. In addition to this, for example, hardware such as a graphics processing unit (GPU) or a field programmable gate array (FPGA) for accelerating the computations may be used. Each functional unit may be implemented by collaboration of software and hardware such as dedicated ICs, or some or all functions may be implemented only by hardware.

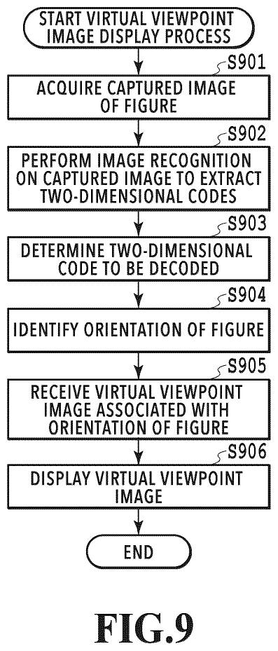

FIG. 9 is a flowchart for describing a process of displaying a virtual viewpoint image stored in association with an orientation of the figure. The series of processes shown in FIG. 9 is implemented by a program stored in the ROM or the HDD of the image acquisition apparatus 130 being deployed on the RAM and executed by the CPU. Alternatively, some or all of the functions of the steps in FIG. 9 may be implemented with hardware such as ASICs and electronic circuits.

In S901, the captured image acquisition unit 801 acquires a captured image obtained by the user capturing the FIG. 500. The captured image is output to the image recognition unit 802.

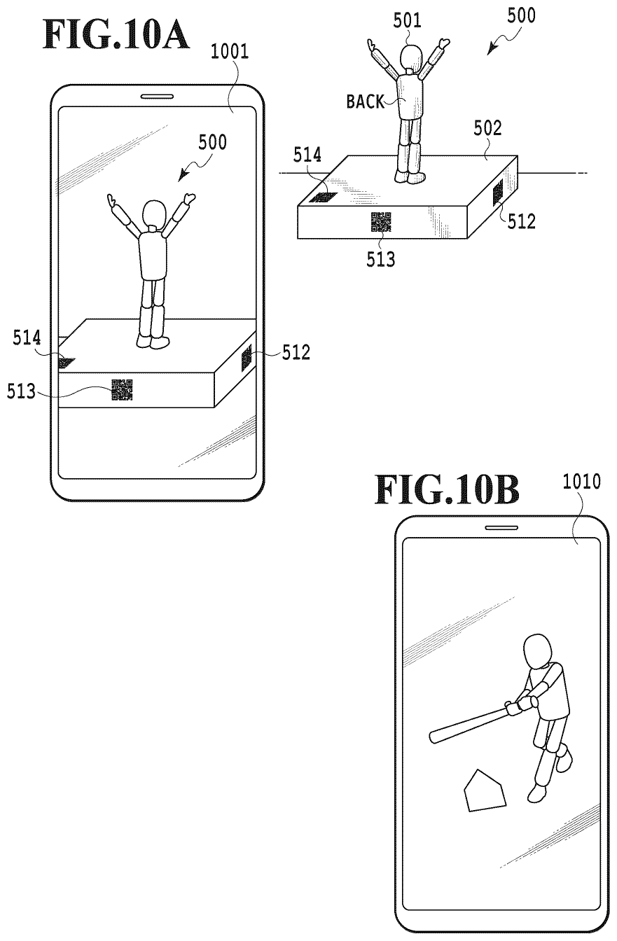

FIGS. 10A and 10B are diagrams for describing a process of displaying a virtual viewpoint image. As shown in FIG. 10A, in a case where the FIG. 500 is captured from its back, a captured image 1001 including the FIG. 500 showing its back is acquired in S901.

In S902, the image recognition unit 802 analyzes the captured image acquired in S901 to extract two-dimensional codes included in the captured image. For example, in a case where the captured image 1001 shown in FIG. 10A is acquired, two-dimensional codes 512-514 included in the captured image 1001 are extracted.

In S903, the determination unit 804 determines a two-dimensional code to be decoded from the extracted two-dimensional codes. For example, in the case of FIG. 10A, the two-dimensional code 513 with the largest size and small distortion among the two-dimensional codes 512-514 included in the captured image 1001 is determined to be decoded.

In S904, the identification unit 803 decodes the determined two-dimensional code to acquire the access information to the storage apparatus 140 and the figure ID identifying the FIG. 500. Furthermore, the identification unit 803 identifies the orientation of the FIG. 500 in the captured image from the information obtained by decoding the determined two-dimensional code to acquire information on the orientation. The identification unit 803 outputs the acquired information to the data access unit 805.

For example, by decoding the two-dimensional code 513 shown in FIG. 10A, the information for accessing the storage apparatus 140 and the figure ID for identifying the FIG. 500 are acquired. In addition, the identification unit 803 determines that the FIG. 500 shows its back in the captured image by decoding the two-dimensional code 513.

In S905, the data access unit 805 accesses the storage apparatus 140 to receive the virtual viewpoint image stored in association with the orientation of the FIG. 500 included in the captured image.

In S906, the display control unit 806 displays the virtual viewpoint image received in S905 on the display unit of the image acquisition apparatus 130, which is the user's terminal.

For example, suppose that the storage apparatus 140 stores virtual viewpoint images as shown in FIG. 6A. In addition, suppose that the figure ID acquired from the two-dimensional code 513 included in the captured image 1001 in S904 is “222”, and the orientation of the FIG. 500 in the captured image is the orientation D indicating the back. In this case, a virtual viewpoint image D having the figure ID of “222” and associated with the orientation D indicating the back is received from the storage apparatus 140. As a result, as shown in FIG. 10B, a virtual viewpoint image 1010, which is the virtual viewpoint image D, is displayed on the display unit of the user's terminal. For example, suppose that the FIG. 500 is a figure generated from the 3D model of the player Z in a scene in which the player Z was happy with a home run. In this case, if the user captures the FIG. 500 from the back, the virtual viewpoint image D, such as the home run scene that led to the scene in which the player Z was happy, can be displayed on the user's terminal.

Note that this embodiment has provided a description assuming that a virtual viewpoint image based on the analysis result of the captured image is displayed on the user's terminal. In addition to this, choices of which virtual viewpoint image to display may be displayed on the user's terminal. For example, in a case where the FIG. 500 is captured, a list of virtual viewpoint images A-F that can be displayed may be displayed on the user's terminal in a list format. The list of virtual viewpoint images may be ordered so that the virtual viewpoint image D associated with the orientation D of the FIG. 500 in the captured image is displayed at the top of the list.

In addition, in a case where the FIG. 500 is placed within the angle of view of the image capturing unit, thumbnails of the virtual viewpoint images A-F associated with the FIG. 500 may be displayed in a superimposed manner. At this time, additionally displaying the orientations of the FIG. 500 associated with the thumbnails on the thumbnails allows the user to be shown which virtual viewpoint image will be displayed by capturing an image in which orientation.

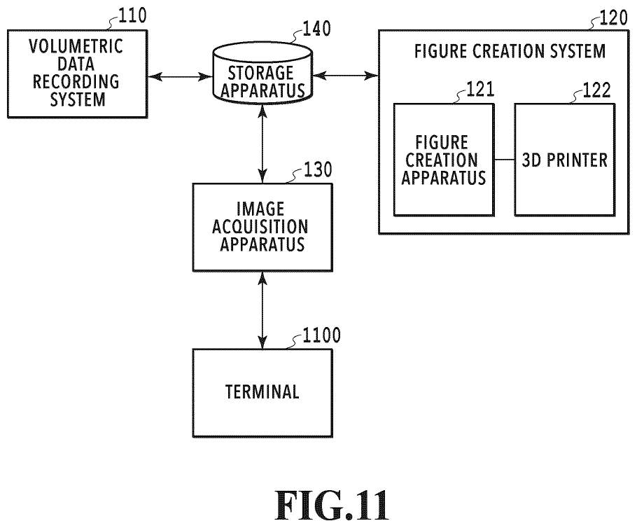

FIG. 11 is a diagram illustrating another example of a system configuration in this embodiment. The image acquisition apparatus 130 has been described as the user's terminal having an image capturing unit and a display unit as an example. In addition to this, the image acquisition apparatus 130 may also be an information processing apparatus such as a server that sends a virtual viewpoint image to the user's terminal 1100 such as a smartphone with an image capturing unit and a display unit. For example, in a case where the user captures an image of the FIG. 500 with the terminal 1100, the terminal 1100 sends the resulting captured image to the image acquisition apparatus 130. As a result, in S901, the captured image acquisition unit 801 may acquire the captured image including the FIG. 500. In addition, in S906, the display control unit 806 may send the data of the virtual viewpoint image received in S905 to the user's terminal 1100, thereby causing the display unit of the terminal 1100 to display the virtual viewpoint image associated with the orientation of the captured FIG. 500.

### Variant 1

Note that the above description has been provided assuming that a virtual viewpoint image is stored in association with the orientation of the figure in the captured image as the state of the figure in the captured image. In addition to this, a virtual viewpoint image may be stored in the storage apparatus 140 in association with the position (distance) of the figure relative to the image capturing apparatus at the time of image capturing by the user, either in place of the orientation of the figure or in addition to the orientation of the figure.

In that case, for example, in the schemes (1)-(4) described as a scheme for generating a virtual viewpoint image, two virtual viewpoint images to be associated with one orientation of the figure may be generated. For example, the virtual viewpoint image generation unit 404 of the figure creation apparatus 121 generates two types of virtual viewpoint images depending on the size of the FIG. 500 included in a captured image obtained by the user capturing the FIG. 500. In a case of generating a virtual viewpoint image A using the schemes (1)-(4), the virtual viewpoint image generation unit 404 may generate two types: a virtual viewpoint image A1 associated with a position near the image capturing apparatus, which is centered on zoom-in, and a virtual viewpoint image A2 associated with a position far from the image capturing apparatus, which is centered on zoom-out. In this way, storing the position (distance) of the FIG. 500 at the time of image capturing and a virtual viewpoint image in association with each other allows linking the size of the FIG. 500 in the captured image obtained by image capturing by the user with the size of the player in the virtual viewpoint image. This makes it easier for the user to expect a virtual viewpoint image to be displayed.

In a case where a virtual viewpoint image is generated in association with the position (distance) of the FIG. 500 relative to the image capturing apparatus, the virtual viewpoint image management unit 405 is assumed to store the virtual viewpoint image in association with the position of the FIG. 500. Note that the virtual viewpoint image management unit 405 may store the virtual viewpoint image in association with the orientation of the FIG. 500 and the position of the FIG. 500.

FIG. 6C shows an example of a method of storing two types of virtual viewpoint images at zoom-in and zoom-out positions in association with the same orientation. As shown in FIG. 6C, the virtual viewpoint image A1 is stored in association with the front orientation A and “zoom-in”, which is information indicating that the image was captured at a zoom-in position. The virtual viewpoint image A2 is stored in association with the front orientation A and “zoom-out”, which is information indicating that the image was captured at a zoom-out position. This enables the virtual viewpoint image A1 to be displayed in a case where the user captures an image of the FIG. 500 from the front at a zoom-in position. Other virtual viewpoint images may be generated in the same way, and the virtual viewpoint images may be managed in further association with information on the position of the FIG. 500 at the time of image capturing in addition to the orientation of the FIG. 500.

In this case, in the image acquisition apparatus 130, the identification unit 803 determines the position (distance) of the FIG. 500 relative to the image capturing apparatus by analyzing the captured image obtained by the user capturing the FIG. 500. For example, the identification unit 803 determines the position (distance) of the FIG. 500 relative to the image capturing apparatus using the size of the two-dimensional code to be decoded included in the captured image. For example, it is only required to determine whether the FIG. 500 has been captured at a zoom-in position or a zoom-out position depending on whether the number (ratio) of pixels in the area of the two-dimensional code to be decoded relative to the size of the entire captured image is greater than or equal to a threshold or not. For example, the identification unit 803 sets the threshold to 0.5%, and determines that the FIG. 500 has been captured at a zoom-in position if the proportion of the area of the two-dimensional code to the entire captured image is 0.5% or more, or determines that it has been captured at a zoom-out position otherwise. Information on whether the FIG. 500 has been captured at a zoom-in position or a zoom-out position is output to the data access unit 805.

The data access unit 805 of the image acquisition apparatus 130 further inputs information on whether the position of the FIG. 500 at the time of image capturing is a zoom-in position or a zoom-out position to the storage apparatus 140 to receive a virtual viewpoint image to be displayed. In addition to this, the data access unit 805 may input the size information of the two-dimensional code to be decoded included in the captured image to the storage apparatus 140 to receive a virtual viewpoint image according to the size of the two-dimensional code from the storage apparatus 140. The size of the two-dimensional code is, for example, the ratio of the size (number of pixels) of the area of the two-dimensional code to the overall size of the captured image as mentioned above.

### Variant 2

The above description has been provided assuming that a virtual viewpoint image is stored in association with at least one of the orientation and the position of the figure as the state of the figure in the captured image. In addition to this, a virtual viewpoint image may be stored in the storage apparatus 140 in association with the posture of the figure at the time of image capturing by the user, either in place of the orientation or the position of the figure or in addition to at least one of the orientation and the position of the figure.

For example, the virtual viewpoint image generation unit 404 of the figure creation apparatus 121 generates a virtual viewpoint image A of a scene in which the player is standing and a virtual viewpoint image B of a scene in which the player is sliding. The virtual viewpoint image management unit 405 may store the virtual viewpoint image A in the storage apparatus 140 in association with information indicating that the FIG. 500 is in a standing posture, and store the virtual viewpoint image B in the storage apparatus 140 in association with information indicating that the FIG. 500 lies on its side.

In this case, in the image acquisition apparatus 130, the identification unit 803 identifies the posture of the FIG. 500 at the time of image capturing by the user by analyzing the captured image obtained by the user capturing the FIG. 500. For example, in a case where the captured image includes a plurality of two-dimensional codes, the identification unit 803 identifies the posture of the FIG. 500 based on the positional relationship between the plurality of two-dimensional codes and their positions on the captured image. In a case where the captured image includes one two-dimensional code, the identification unit 803 determines whether the orientation of the two-dimensional code is up, down, left, or right, and identifies the posture of the FIG. 500 based on the determination result. The information on the posture of the FIG. 500 is output to the data access unit 805. The data access unit 805 of the image acquisition apparatus 130 further inputs the information on the posture of the FIG. 500 at the time of image capturing to the storage apparatus 140 to receive the virtual viewpoint image to be displayed. As a result, a virtual viewpoint image associated with the posture of the FIG. 500 at the time of the user capturing an image of the FIG. 500 is displayed to the user.

### Variant 3

The above has described a method of identifying the orientation, the position, and the posture of the FIG. 500 from the captured image obtained by the user capturing the FIG. 500 based on the two-dimensional codes assigned to the FIG. 500. This method is an example, and the method of identifying the state of the figure in the captured image, such as the orientation, the position, and the posture of the FIG. 500, is not limited.

For example, the figure image registration unit 403 of the figure creation apparatus 121 registers captured images of the FIG. 500 in advance. The figure creator uses an image capturing apparatus not shown to capture images of the FIG. 500 modeled by the 3D printer 122 from a plurality of directions and a plurality of positions, or capture images of the FIG. 500 in various postures. Then, the resulting captured images are input to the figure creation apparatus 121. The figure image registration unit 403 registers the input captured images in the storage apparatus 140. In this case, the identification unit 803 of the image acquisition apparatus 130 may identify the orientation, the position, or the posture of the FIG. 500 by comparing a captured image obtained by the user capturing the FIG. 500 with the captured images registered by the figure image registration unit 403.

Alternatively, the identification unit 803 may recognize parts of the FIG. 500 included in the captured image such as its hands or foots by image recognition, and identify the orientation, the position, or the posture of the FIG. 500 based on the recognized parts. Alternatively, the orientation, the position, or the posture of the FIG. 500 may be identified from the shape or colors of the FIG. 500.

### Variant 4

The above has described that capturing an image of the FIG. 500 results in displaying virtual viewpoint images of the target scene associated with the FIG. 500, that is, a plurality of virtual viewpoint images corresponding to the target scene. In addition to this, it is also possible to display a countdown indicating the timing of displaying the virtual viewpoint image generated using the 3D model used in creating the figure among the plurality of virtual viewpoint images corresponding to the target scene.

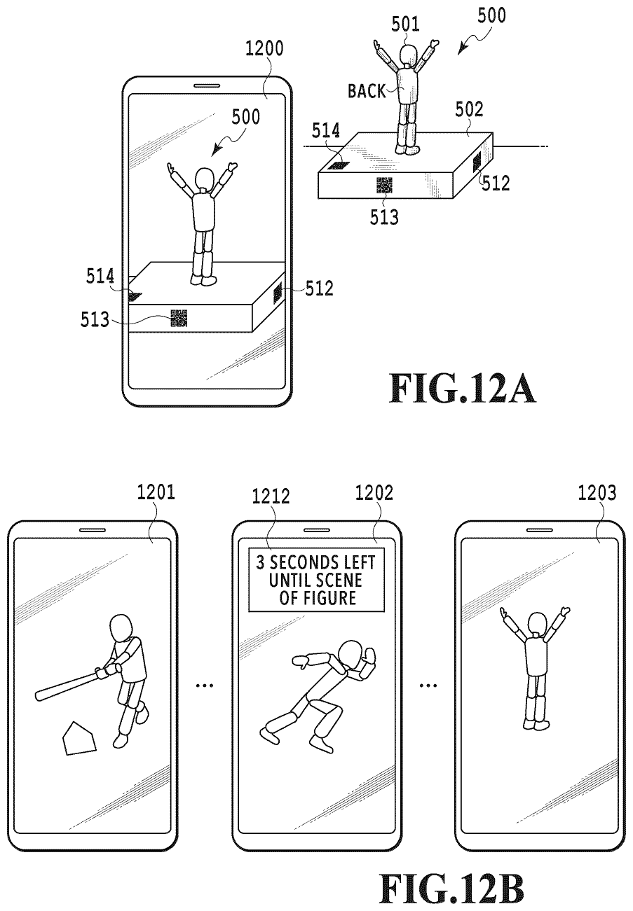

FIGS. 12A and 12B are diagrams for describing a process of displaying virtual viewpoint images according to a variant 4. As explained above, virtual viewpoint images may be generated using the target object in the target scene used to create the figure as virtual viewpoint images associated with the figure. In this case, the time from the frame corresponding to the virtual viewpoint image displayed on the image acquisition apparatus 130 to the target frame corresponding to the 3D model used to create the figure is calculated, and the countdown is displayed together with the virtual viewpoint image. Displaying the countdown in this way allows the user to easily grasp the target frame from which the figure was created.

For example, suppose that the target scene is a scene in which the player Z hit a home run. Suppose that the FIG. 500 included in the captured image 1200 shown in FIG. 12A is a figure generated from a 3D model of the player Z who was happy in the frame (target frame) after the home run in the target scene. FIG. 12B is a diagram showing a moving image from a virtual viewpoint image 1201 corresponding to the frame of a home run that led to the player Z's happiness to a virtual viewpoint image 1203 corresponding to the target frame in which the player Z was happy that was used for the FIG. 500. In this way, a moving image consisting of virtual viewpoint images of a plurality of frames from the frame in which the event as the premise of the FIG. 500 occurred to the target frame used for the FIG. 500 may be stored in association with a state of the FIG. 500. At this time, the virtual viewpoint images may be stored so that the target scene can be identified among the frames that constitute the moving image. Then, in a case where the image acquisition apparatus 130 displays virtual viewpoint images of a plurality of frames, the display control unit 806 calculates the time until the display of the virtual viewpoint image 1203 of the target frame used to create the FIG. 500. Then, the display control unit 806 may display a countdown 1212 indicating the time until the display of the virtual viewpoint image 1203 corresponding to the target frame, as shown in a virtual viewpoint image 1202 corresponding to a frame before the target frame.

Note that the display method is not limited to a countdown as long as the user can easily grasp the target frame from which the figure was created. For example, the target object may be highlighted in the virtual viewpoint image corresponding to the target frame from which the figure was created. Examples of highlighting include various display methods, such as changing colors, or superimposing CG on the target object. In addition to highlighting, the display time of the target frame from which the figure was created may be extended. For example, in a case where each of the plurality of virtual viewpoint images corresponding to the target scene is displayed at 60 fps, the plurality of virtual viewpoint images corresponding to the two seconds before and after the target frame from which the figure was created may be displayed at 5 fps. Thus, the frames before and after the frame from which the figure was created are slowly displayed, enabling the user to easily grasp the target frame from which the figure was created. Note that in addition to slow display, only the time for displaying the target frame from which the figure was created may be increased.

As described above, according to this embodiment, different images are stored in association with a plurality of states (orientations, positions, or postures) of a figure. Thus, in a case where an image of the figure is captured, an image associated with the state (orientation, position, or posture) of the figure in the captured image can be displayed to the user. For this reason, by capturing images of the figure in various orientations, postures, and positions, the user can appreciate and enjoy different images depending on the orientation, the posture, or the position of the figure at the time of image capturing. In addition, in this embodiment, virtual viewpoint images are generated in advance, and the generated virtual viewpoint images and the states (orientations, positions, or postures) of the figure are stored in advance in association with each other. Therefore, this embodiment can reduce the processing load until a virtual viewpoint image is displayed, compared to a case where a virtual viewpoint image is generated each time and the generated virtual viewpoint image is displayed.

Since the method of Japanese Patent Laid-Open No. 2022-131778 only generates a virtual viewpoint image of a specific object in a specific scene viewed from a specific viewpoint, it has been sometimes impossible for a user who captures images of a figure to appreciate various images.

According to the present disclosure, various images can be displayed depending on image capturing of a figure.

### Other Embodiments

This embodiment is also implemented by supplying a system with a storage medium that records a computer program code for implementing the above functions and the system reading out and executing the computer program code. In this case, the computer program code itself read out from the storage medium implements the functions of the above embodiment, and the storage medium storing the computer program code constitutes the technique of the present disclosure. In addition, an OS or the like running on a computer may perform part or all of the actual processing using the above hardware resources based on instructions of the program code, thereby implementing the above functions.

Furthermore, this embodiment may be implemented in the following form. That is, the computer program code read out from the storage medium is written to a memory provided in a function expansion card inserted into the computer or a function expansion unit connected to the computer. Then, the CPU or the like provided in the function expansion card or the function extension unit may perform part or all of the actual processing based on instructions of the computer program code to implement the above functions.

In a case where this embodiment is applied to the above storage medium, a computer program code corresponding to the processing described earlier is stored in the storage medium.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229348, filed Dec. 25, 2024, which is hereby incorporated by reference herein in its entirety.

What is claimed is:

1. An information processing apparatus comprising:
one or more memories storing instructions; and
one or more processors executing the instructions to:
acquire a captured image including a figure;
receive a virtual viewpoint image stored in association with a state of the figure included in the captured image from a storage apparatus in which different virtual viewpoint images are associated with a plurality of respective states of the figure; and
perform a process of displaying the received virtual viewpoint image.

2. The information processing apparatus according to claim 1, wherein
the plurality of states are at least one of a plurality of orientations, a plurality of postures, and a plurality of positions of the figure.

3. The information processing apparatus according to claim 1, wherein
the one or more processors further identify the state of the figure included in the captured image, and
the received virtual viewpoint image is a virtual viewpoint image stored in association with the identified state of the figure.

4. The information processing apparatus according to claim 3, wherein
the figure is marked with first information for identifying the state of the figure, and
the state of the figure is identified from the first information included in the captured image.

5. The information processing apparatus according to claim 3, wherein
the plurality of states are a plurality of orientations of the figure,
the figure is marked, at a position corresponding to each orientation, with a code image in which information indicating the orientation is encoded, and
the orientation of the figure is identified as the state of the figure by decoding the code image included in the captured image.

6. The information processing apparatus according to claim 1, wherein
the figure is marked with second information for accessing the storage apparatus.

7. The information processing apparatus according to claim 3, wherein
the storage apparatus stores virtual viewpoint images associated with the plurality of states for each of a plurality of figures,
the figure is marked with third information for identifying the figure, and
the received virtual viewpoint image is a virtual viewpoint image stored in the storage apparatus in association with the figure indicated by the third information and the identified state of the figure.

8. The information processing apparatus according to claim 1, wherein
the figure is a figure generated based on a piece of three-dimensional shape data of a target object in a target scene from among pieces of three-dimensional shape data in units of frames generated based on a plurality of capturing apparatuses capturing a target area, and
the virtual viewpoint images associated with the plurality of respective states include a virtual viewpoint image of a predetermined object in a predetermined scene viewed from a virtual viewpoint generated based on the pieces of three-dimensional shape data in units of frames.

9. The information processing apparatus according to claim 8, wherein
the virtual viewpoint images associated with the plurality of respective states include a virtual viewpoint image of the target object in the target scene viewed from a virtual viewpoint.

10. The information processing apparatus according to claim 8, wherein
the virtual viewpoint images associated with the plurality of respective states include a virtual viewpoint image of the target object in a scene different from the target scene viewed from a virtual viewpoint.

11. The information processing apparatus according to claim 8, wherein
the virtual viewpoint images associated with the plurality of respective states include a virtual viewpoint image of an object different from the target object in the target scene viewed from a virtual viewpoint.

12. The information processing apparatus according to claim 8, wherein
the virtual viewpoint images associated with the plurality of respective states include a virtual viewpoint image of an object different from the target object in a scene different from the target scene viewed from a virtual viewpoint.

13. The information processing apparatus according to claim 1, further comprising
an image capturing unit and a display unit, wherein
the acquired captured image is a captured image obtained as a result of the image capturing unit capturing the figure and includes the figure, and
the received virtual viewpoint image is displayed on the display unit.

14. The information processing apparatus according to claim 1, wherein
the information processing apparatus is capable of communicating with a terminal comprising an image capturing unit and a display unit,
the acquired captured image is a captured image obtained as a result of the image capturing unit capturing the figure, includes the figure, and is sent from the terminal, and
the information processing apparatus sends data of the received virtual viewpoint image to the terminal so that the received virtual viewpoint image is displayed on the display unit as the process for displaying the received virtual viewpoint image.

15. A figure creation apparatus comprising:
one or more memories storing instructions; and
one or more processors executing the instructions to:
generate modeling data of a figure;
generate a plurality of different virtual viewpoint images; and
perform a process of storing the plurality of different virtual viewpoint images in a storage apparatus in association with a plurality of respective states of the figure so that a virtual viewpoint image corresponding to a state of the figure is displayed in a case where an image of the figure is captured.

16. The figure creation apparatus according to claim 15, wherein
the modeling data is generated so that the figure is marked with information for identifying the state of the figure in captured image of the figure.

17. An information processing method comprising:
acquiring a captured image including a figure;
receiving a virtual viewpoint image stored in association with a state of the figure included in the captured image from a storage apparatus in which different virtual viewpoint images are associated with a plurality of respective states of the figure; and
performing a process of displaying the received virtual viewpoint image.

18. A figure creation method comprising:
generating modeling data of a figure;
generating a plurality of different virtual viewpoint images; and
performing a process of storing the plurality of different virtual viewpoint images in a storage apparatus in association with a plurality of respective states of the figure so that a virtual viewpoint image corresponding to a state of the figure is displayed in a case where an image of the figure is captured.

19. A non-transitory computer readable storage medium storing a program which causes a computer to perform an information processing method, the information processing method comprising:
acquiring a captured image including a figure;
receiving a virtual viewpoint image stored in association with a state of the figure included in the captured image from a storage apparatus in which different virtual viewpoint images are associated with a plurality of respective states of the figure; and
performing a process of displaying the received virtual viewpoint image.

20. A non-transitory computer readable storage medium storing a program which causes a computer to perform a figure creation method, the figure creation method comprising:
generating modeling data of a figure;
generating a plurality of different virtual viewpoint images; and
performing a process of storing the plurality of different virtual viewpoint images in a storage apparatus in association with a plurality of respective states of the figure so that a virtual viewpoint image corresponding to a state of the figure is displayed in a case where an image of the figure is captured.
